(19) United States
(12) Patent Application Publication
(10) Pub. No.: US 2012/0125267 A1
(43) Pub. Date: May 24, 2012

(54) CANINE CHEW PET TOY

(76) Inventor: Sara Kelly, San Francisco, CA (US)

(21) Appl. No.: 12/953,225

(22) Filed: Nov. 23, 2010

(51) Int. Cl. A01K 29/00

(52) U.S. Cl. 119/710

(57) ABSTRACT

A canine chew toy in the form of a combination of one or more plastic bottles, each bottle having a body portion and a fill opening and a hub having a hub body. Configured within the hub body is one or more hub openings, each opening sized to receive and to frictionally secure one of the plastic bottles at its fill opening.

### TECHNICAL FIELD

The present invention involves a pet activity toy primarily intended for use by domestic dogs. The toy satisfies the need for a dog to bite and chew and based upon ongoing evaluation, most dogs find the present toy extremely satisfying and yet is inexpensive to create and replenish with inexpensive replacement parts. Further, the present chew toy enables a pet owner to reuse plastic bottles which otherwise would have been discarded and placed in landfill.

### BACKGROUND OF THE INVENTION

Domesticated dogs, as most know, make ideal pets as they we generally friendly, loyal and can be trained to assume a number of tasks and are obedient. Many dogs, however, have the need to bite and chew, a tendency which begins as puppies but often times can continue well into adulthood. As a result, there have been a wide variety of chew toys sold in the marketplace. These chew toys, ranging from rope products to hard rubber items are selected to be on the one hand durable and on the other sufficiently non-irritating

It has been recognized that dogs find it particularly appealing to bite down upon an object which has some “give” to its body and can emanate a sound or some physical feedback during the biting and chewing process. In satisfying these various requirements, applicant has learned that dogs react quite favorably to biting and chewing empty plastic bottles, such as the soft drink and water bottles so commonly available in supermarkets and grocery stores. The plastic beverage bottle, composed of polyethylene terephthalate, appears to have the ideal characteristics of a chew toy as the body portion of the emptied bottle exhibits excellent “give” and yet emanates a crackle sound when compressed through chewing.

Although a pet owner could simply introduce his or her dog to an empty plastic bottle, converting such a container to a pet toy has much more potential if the present invention was to be adopted. Through this invention, a plastic bottle can be releasably attached to a central hub and as a preferred embodiment, multiple plastic bottles can be selectively joined to a centrally located hub which itself can be composed of rubber, plastic or wood enabling the dog to have yet another surface for chewing. In addition, once plastic bottles have been chewed upon to such an extent that they no longer serve the function of a pet toy, they simply can be removed from the central hub and replaced with yet another emptied plastic bottle Thus, the chew toy of the present invention cannot only make use of discarded plastic products which would otherwise simply enter into a landfill, but also can enable a pet owner to constantly renew his or her pet toy by simply joining a new plastic bottle to the hub body of the present invention thus creating a virtually new chew toy at anytime. Further, to enhance interest in the present chew toy, edible treats can be placed in the plastic bottles and in the hub as desired.

These and further objects will be more readily appreciated when considering the following disclosure and appended claims

### SUMMARY OF THE INVENTION

A canine chew toy in the form of a combination of one or more plastic bottles, each bottle having a body portion and a fill opening and a hub having a hub body. Configured within the hub body is one or more openings, each opening sized to receive and to frictionally secure one of the plastic bottles at its fill opening. The hub can also be configured to receive pet treats and other toys to enhance interest in the toy.

### BRIEF DESCRIPTION OF THE FIGURES

FIG. 1 is a side view of a first embodiment of the present invention.

FIG. 2 is a partial cross-sectional view taken along line 2-2 of FIG. 1.

FIG. 3 is a side view of a second embodiment of the present invention.

FIG. 4 is a side view of yet another embodiment of the present invention.

FIG. 5 is a side view of an adaptor element useful in practicing each of the embodiments discussed above

FIG. 6 is a plan view of a further embodiment of the present invention in which a rope segment is used to tether hub components together.

FIG. 7 is a side view of the present invention showing the inclusion of food treats placed within the bottle portion thereof.

FIG. 8 is a partial side view of the present invention in which food treats have been placed within its hub portion.

FIG. 9 is a perspective view of a further embodiment of the present invention in which its hub has been connected to a pet toy to increase a pet's interest thereof.

FIG. 10 is a perspective view of yet a further embodiment of the present invention in which a rope is used as a handle.

FIG. 11 is a perspective view of still a further embodiment of the present invention in which a plush toy is removably attached to one of the hub elements used herein.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention The various features of novelty which characterize the invention are recited with particularity in the claims

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

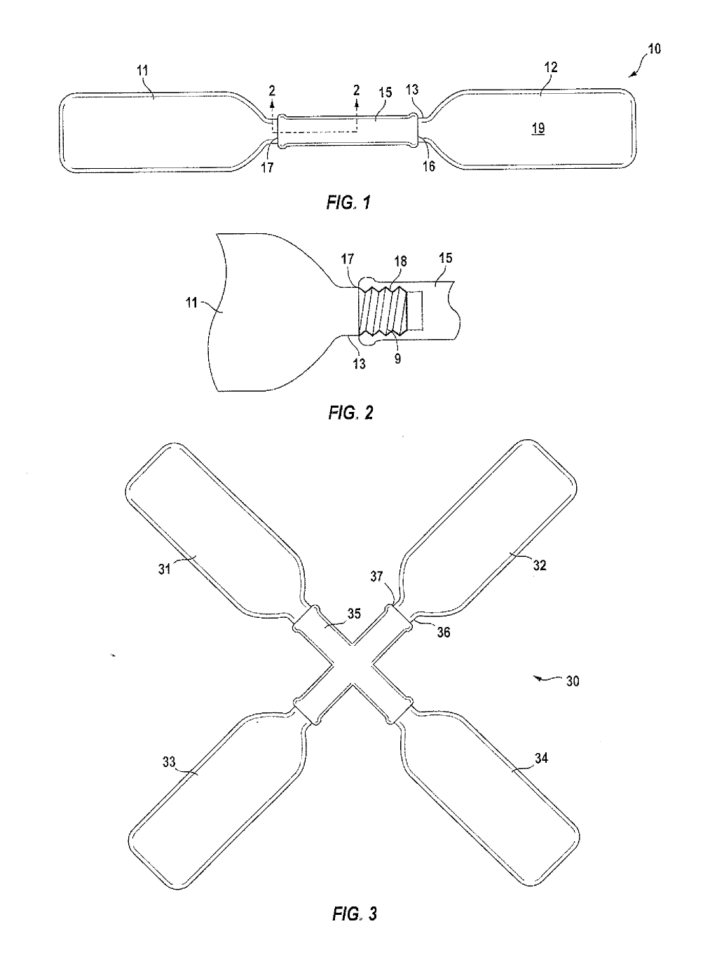

FIG. 1 represents a first embodiment of the present invention in the form of canine chew toy 10. As noted, the invention is, in combination, one or more plastic bottles, in this illustration two such bottles 11 and 12 are shown, each bottle having a body portion 19 and a fill opening best seen in FIG. 2 as element 9 Fill opening 9 is at the terminal end of neck portion 13 and, when it comes to plastic bottles which previously were used to contain beverages, neck portions 13 terminates in a series of screw threads 17 which were used to engage a cap for resealing the beverage container between uses.

Canine chew toy 10 is shown having, as part thereof, a hub having hub body 15, in this instance, being cylindrically shaped In providing hub body 15, both plastic bottles 11 and 12 can releasably engage the hub body by releasably inserting neck portion 13 within openings 16 and 17

In turning to FIG. 2, it is noted that when plastic bottle 11 is provided with threaded portion 17, hub body 15 is provided with mating threads 18 to enable plastic bottles 11 and 12 to releasably engage hub 15 by screwing plastic bottles 11 and 12 therein and removing them for replacement once a dog has engaged pet toy 10 to the extent of degrading either of the plastic bottles to such an extent that a replacement is deemed appropriate

As a further example of an embodiment of the present invention, reference is made to FIG. 3 wherein hub body 35 is shown as being cross shaped thus having four openings 37 for releasably receiving plastic bottles 31, 32, 33 and 34. It should be appreciated that when using the embodiment of FIG. 3 providing for chew toy 30, that not all four hub openings need be employed at any given time. However, such an embodiment provides an interesting chew toy for a pet dog as the dog has a number of options to chew upon at will

It should also be appreciated that although the chew toys described herein have been characterized as receiving, typically, plastic bottles that have been used for beverages, any type of plastic bottle can be used and, as noted later in this disclosure, plastic bottles can be employed that do not necessarily have screw threads

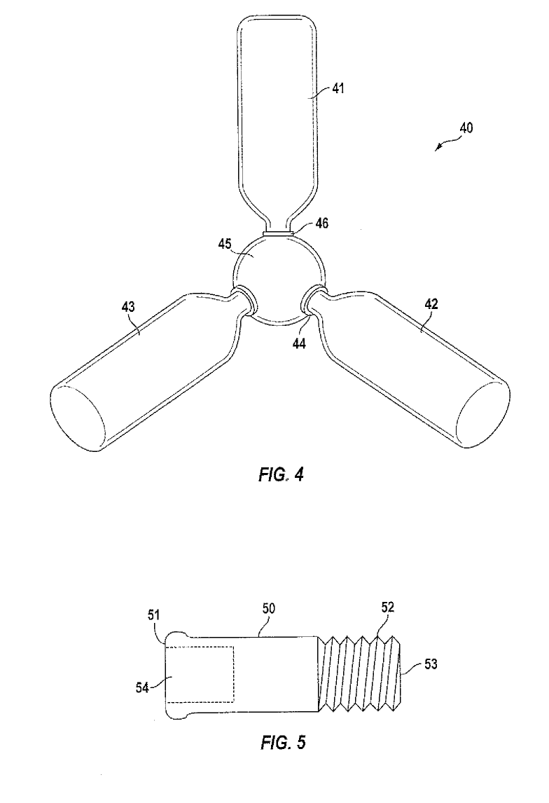

In turning to FIG. 4, yet a further iteration of the present invention is shown, in this instance, hub body 45 in the form of a sphere having a number of hub openings 46 for receiving plastic bottles 41, 42 and 43 Being spherically shaped, depending upon the size of hub body 45, virtually any number of openings 46 can be employed for the receipt of any particular number of plastic bottles.

It should be quite apparent from the above discussion that the examples shown in FIGS. 1, 3 and 4 are representative illustrations of various geometric structures that can be configured out of, for example, rubber, plastic or wood which can be provided with any number of hub body openings for the receipt of a corresponding number of plastic bottles or pet treats. As such, the examples of FIGS. 1, 3 and 4 are merely illustrative of the myriad of choices one has in practicing the present invention.

As noted previously, a hub body, such as hub body 15 can be employed to releasably receive plastic bottles which do not necessarily have a threaded region emanating from the neck portion of the bottle. In this regard, reference is made to FIG. 5.

In turning to FIG. 5, adaptor 50 is shown having threaded portion 53 extending to end 52. When employing a plastic bottle without screw threads, it is proposed that adaptor 50 be screwed within corresponding screw threads, such as threads 18 of FIG. 2 leaving the body portion of adaptor 50 extending therefrom. Adaptor 50 is then configured with a recess 54 which is devoid of screw threads. Recess 54 is sized to frictionally receive the neck portion of a suitable plastic bottle at end 51 thus enabling a hub with threaded openings to receive plastic bottles without a corresponding threaded neck region

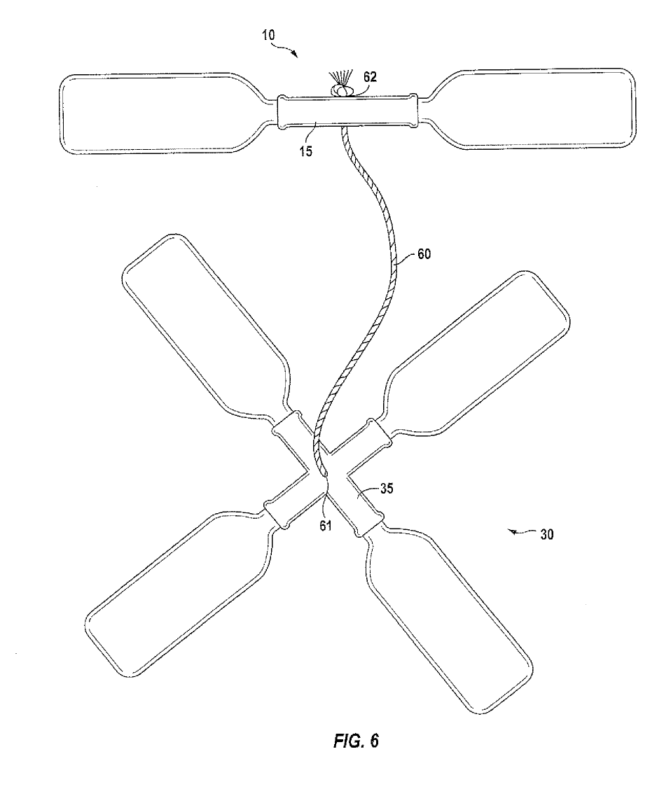

In turning to FIG. 6, yet a further embodiment of the present invention is illustrated. Specifically, rope segment 60 is shown emanating from hub body 35 at hub point 61. As will be described with respect to FIG. 10, rope segment 60 could simply terminate at free end 62 allowing a pet owner to grasp rope segment 60 in order to hold pet toy 30 as a dog pulls upon the pet toy by grasping one of the plastic bottles or by grasping hub body 35 In addition, free end 62 of rope segment 60 can be appended to hub body 15 of pet toy 10 enabling two such pet toys to be connected to one another to enhance the flexibility of the present invention.

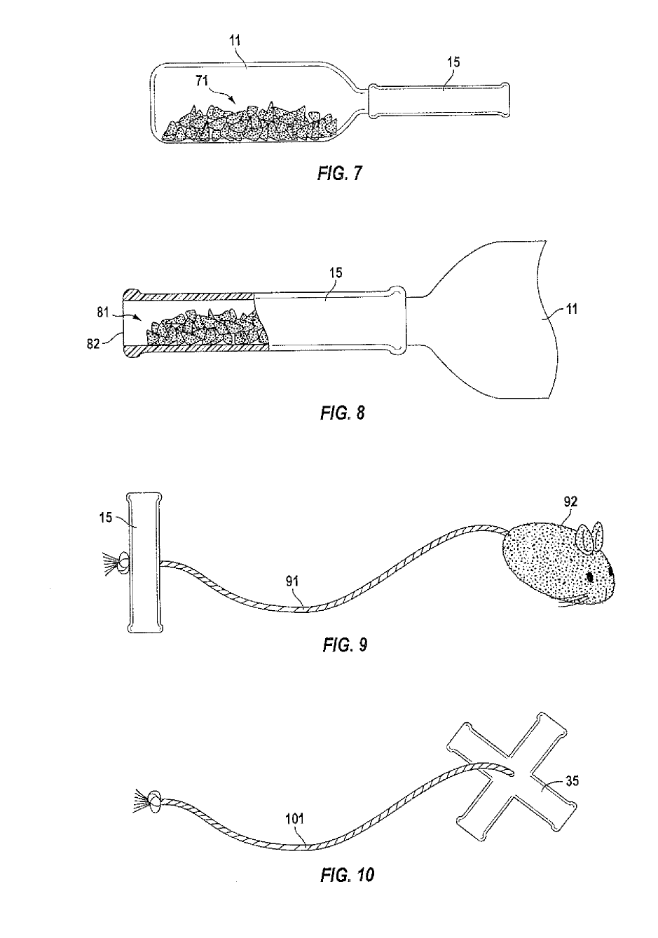

To further enhance a pet's interest in the present invention, reference is made to FIG. 7. Specifically, food treats 71 have been placed within plastic bottle 11. Thus, a pet would realize quite rapidly that there was a reward within plastic bottle 11 if the pet was successful in gaining access to the bottle's interior

Similarly, in turning to FIG. 8, pet treats 81 can be placed within hub body 15 as shown by simply adding the food treats through open end 82. Alternatively, treats 71 (FIG. 7) placed within plastic bottle 11 could spill to the interior of hub body 15 if the latter was hollow creating an open passageway.

As yet a further embodiment, hub body 15 could be connected to tope segment 91 such that as a pet was to bite and shake upon hub body 15 or a plastic bottle appended thereto (not shown), plush toy 92 would respond thus, again, enhancing the interest that the present invention would create for the engaged pet

In turning to FIG. 10, it is noted that rope segment 101 can be connected to a hub, such as hub 35 thus creating a rope handle. Such a handle can be grasped by the pet owner and used to move and shake hub 35 and any plastic bottles connected thereto as a means of playing “tug-of-war” or holding the toy somewhat out of reach to create a challenge for the engaged pet.

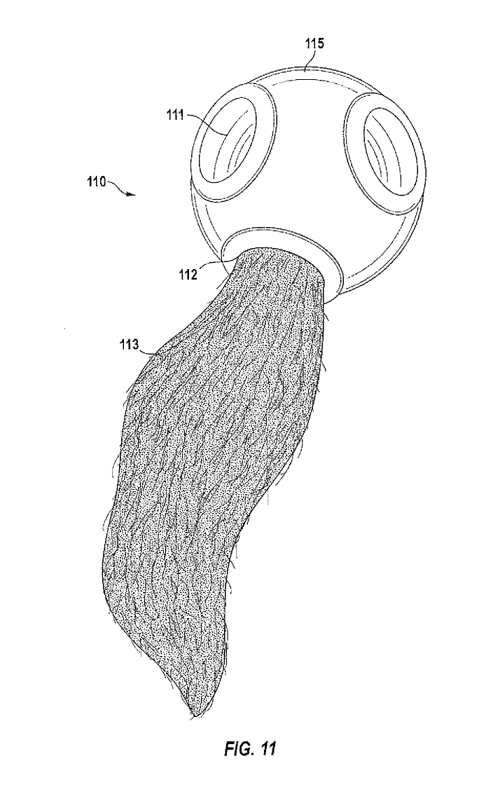

Finally, reference is made to FIG. 11 illustrating yet a further embodiment of the present invention. In this instance, canine chew toy 110 is shown having a hub section similar to that illustrated in FIG. 4 (element 45). Hub element 115 is configured with openings 111 designed primarily to releasably accept plastic bottles as discussed previously. In this instance, opening 112 is shown receiving plush toy 113. Plush toy 113 can ideally be configured with a threaded end (not shown) intended to mate with a similar threaded section within opening 112 to enable a pet owner to exchange plush toy 113 with a plastic bottle or with another plush toy or simply to remove plush toy 113 when it has been sufficiently degraded as a result of it being chewed upon as intended

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A canine chew toy comprising in combination one or more plastic bottles, each bottle having a body portion and fill opening, a hub having a hub body and configured within said hub body one or more hub openings, at least one of said hub openings sized to receive and to releasably secure a plastic bottle at its fill opening.

2. The canine chew toy of claim 1 wherein said fill openings and said hub openings are threaded to facilitate screw connection and removal of said plastic bottles to and from said hub.

3. The canine chew toy of claim 1 wherein said hub body is cylindrically shaped having two hub openings for releasably receiving two plastic bottles.

4. The canine chew toy of claim 1 wherein said hub body is cross shaped having four hub openings for releasably receiving four plastic bottles.

5. The canine chew toy of claim 1 wherein said hub is spherically shaped having four hub openings for releasably receiving four plastic bottles.

6. The canine chew toy of claim 1 wherein said hub comprises a rubber body.

7. The canine chew toy of claim 1 further comprising a rope segment attached to and emanating from said hub body.

8. The canine chew toy of claim 7 wherein said rope segment is attached to two hub bodies

9. The canine chew toy of claim 7 wherein one end of said rope segment is free to grasp by a user.

10. The canine chew toy of claim 1 wherein said fill opening and hub opening are sized to facilitate frictional capture of said plastic bottles by said hub body.

11. The canine chew toy of claim 1 further comprising an adaptor, one end of said adaptor having a male end sized to be releasably retained by a hub opening and having a female end sized to releasably receive the fill opening of the plastic bottle.

12. The canine chew toy of claim 1 further comprising food treats contained within said one or more plastic bottles.

13. The canine chew toy of claim 1 further comprising food treats within said hub body.

14. The canine chew toy of claim 1 further comprising a pet toy appended to said hub body.

15. The canine chew toy of claim 14 wherein said pet toy is appended to said hub body through use of a rope segment.

16. A canine chew toy comprising a plastic bottle having a body portion and fill opening, a hub having a hub body and configured within said hub body, at least one opening sized to receive and to releasably secure said plastic bottle at its fill opening.
